(19) United States
(12) Patent Application Publication
(10) Pub. No.: US 2007/0245814 A1
(43) Pub. Date: Oct. 25, 2007

(54) MAGNETIC DISK DEFECT TEST METHOD, PROTRUSION TEST DEVICE AND GLIDE TESTER

(76) Inventors: Kenichi Shitara, Kanagawa (JP); Keiichi Takamura, Kanagawa (JP); Takao Ishii, Kanagawa (JP)

Correspondence Address: MATTINGLY, STANGER, MALUR & BRUNDIDGE, P.C., Suite 370, 1800 Diagonal Road, Alexandria, VA, 22314, US

(21) Appl. No.: 11/697,809

(22) Filed: Apr. 9, 2007

(30) Foreign Application Priority Data
Apr. 11, 2006 (JP) 2006-108517

(51) Int. Cl. B23Q 17/09; G11B 5/02

(52) U.S. Cl. 73/104; 360/25

(57) ABSTRACT

Acceptability of a disk is determined by passing a detection signal from a head through a low-pass filter to obtain a detection signal component corresponding to side runout of the disk due to rotation of the disk and by comparing the maximum level of the signal with a predetermined reference value. Thus, it is possible to extract unacceptable disk which causes erroneous write and/or read or clash due to surface undulation of disk, even when the disk has no protrusion having bad influence upon the disk.

### TECHNICAL FIELD

The present invention relates to a magnetic disk defect test method, a protrusion test device and a glide tester and, particularly, the present invention relates to a magnetic disk defect test method capable of testing surface undulation of a magnetic disk and of improving preciseness of acceptability determination of a magnetic disk.

### BACKGROUND ART

It has been requested to increase recording density of and reduce the size of the magnetic disk used as an information recording medium for a computer, etc.

A hard magnetic disc which is one of information recording media is fabricated by painting surfaces of a glass substrate or an aluminum substrate as a base with a magnetic material. It is required that the magnetic films have flat surfaces having no unevenness such as protrusion or bump. Therefore, the surfaces of the magnetic disk are flattened by polishing in a burnishing step. However, since protrusions might be left even when the disk is flattened by the burnishing step, the flatness of magnetic disk is tested by using a protrusion test device and, if there is protrusion left, the magnetic disk is further polished by returning it to the burnishing step.

JP-6-341825A and JP-7-6365A disclose a protrusion test device. In the disclosed protrusion test device, in order to detect height of a protrusion on a magnetic disk, the magnetic disk is rotated at a predetermined peripheral speed to float a slider having a thin film head up to a constant level and, when the slider collides with protrusion on the magnetic disk, vibration of the slider caused by the collision is converted into an electric signal as a protrusion detection signal by a piezoelectric sensor (piezo element) mounted on the slider. Incidentally, the thin film head of the slider may be removed.

With increase of the recording density of a magnetic disk, an amount of floating of the magnetic head is reduced. In a magnetic disk of 1.8 inches or smaller, a slider having an area of 3 mm×3 mm to 5 mm×5 mm is mounted on a top end of a suspension spring about 15 mm to 20 mm long and a distance between the thin film magnetic head and the magnetic disk is 10-odd nanometers to several tens nanometers.

For a magnetic disk having size of 1.8 inches or more, the rotation number has been increased from 5,400 rpm to 7,200 rpm, recently, and even a hard disk drive device (HDD) in which a magnetic disk is rotated at a speed in a range 15,000 rpm to 20,000 rpm has been sold. Even for a 1.8 inches magnetic disk or smaller, the rotation number is increased from 4,200 rpm to 5,400 rpm or more.

Therefore, the importance of the protrusion test (glide test) of surface of a magnetic disk in determining acceptability of disk is increased.

When the distance between the magnetic head and the magnetic disk is reduced to a value in the range from 10-odd nanometers to several tens nanometers, the height of protrusion to be detected becomes 10-odd nanometers or less. Further, in detecting protrusion having such low height, both height of protrusion and side runout of a magnetic disk due to rotation of the disk become problems. When the distance between the magnetic head and the disk is reduced to the above mentioned value and an amount of side runout of the disk is increased, erroneous write and/or read and the head crush may occur. Therefore, even if there is no protrusion having height which may cause problem, the disk has to be determined as unacceptable.

The side runout occurs due to degradation of balance of a disk caused by the undulation of disk surface and the eccentricity of disk with respect to a rotation center thereof and, when thickness of a recent glass disk is increased to 0.3 mm to 0.5 mm, the side runout tends to occur by the undulation of disk surface when the disk is rotated.

### SUMMARY OF THE INVENTION

An object of the present invention is to provide a magnetic disk defect test method capable of testing surface undulation of a magnetic disk and of improving preciseness of acceptability determination of a magnetic disk.

Another object of the present invention is to provide a disk defect test device capable of improving preciseness of acceptability test of a magnetic disk by testing protrusion existing on surfaces of the magnetic disk and the side runout of the disk.

A further object of the present invention is to provide a glide tester capable of improving preciseness of acceptability test of disk by testing the protrusion existing on disk surfaces and the surface undulation of a disk.

In order to achieve these objects, the disk defect test method, the protrusion test device or the glide tester according to the present invention, in which a head having a slider on which a piezoelectric sensor is mounted is floated up to a predetermined level by rotating a magnetic disk and the disk is tested by an electric signal from the piezoelectric sensor as a detection signal. A detection signal component corresponding to side runout of the rotating disk is obtained by passing the detection signal through a low-pass filter. Acceptability of disk is determined by comparing a maximum level of the signal component with a first predetermined reference value.

As mentioned above, according to the present invention, the acceptability of the disk is determined by comparing a maximum level of the signal component corresponding to side runout of the rotating disk, which is obtained by passing the detection signal through a low-pass filter, with a first predetermined reference value. Therefore, even when there is no protrusion having height, which causes a problem, in the disk, it is possible to extract unacceptable disk which may cause erroneous write and/or read or crash of the disk due to surface undulation thereof.

The reason why the signal indicative of the side runout is obtained through the low-pass filter is that, when a disk having a surface undulation or eccentricity is rotated, a side runout corresponding to rotation of the disk tends to occur. The amount of the runout is larger than that of a normal disk. When the amount of side runout is detected, it includes not only the surface undulation but also side runout of an eccentric disk. In the present invention, such eccentric disk is deemed as a disk having surface undulation for reasons that the side runout of a disk having thickness of 0.3 mm to 0.5 mm as the recent glass disk tends to occur due to surface undulation of the disk when it is rotated, that an eccentric disk causing side runout larger than a certain reference can be considered as unacceptable disk since erroneous write and/or read tend to occur and that the number of such eccentric disks is smaller than that of the disks having surface undulation.

That is, in the present invention, an amount of side runout of a disk when the latter is rotated is detected as an amount of surface undulation thereof and the acceptability of the disk is determined on the basis of the amount of side runout.

It is usual currently that a disk surface is polished in the burnishing step in such a way that the height of protrusion thereof becomes, for example, 10 nm or less. When the protrusion height becomes 10 nm or less, for example, 8 nm or less, a collision signal obtained from the piezoelectric sensor mounted on the slider having an area of 5 mm×5 mm or less by collision of the slider with the protrusion exhibits not vibration waveform but peak waveform overlapped with noise as shown in FIG. 2(b).

Frequency corresponding to side runout and obtained by the protrusion detection head depends on the rotation number of disk. Since it is considered that the maximum rotation is 30,000 rpm or less currently, vibrations frequency detected by the piezoelectric sensor through vibrating air when the disk is rotated at 30,000 rpm or less becomes about 100 kHz to 500 kHz. Therefore, it is possible to obtain signal whose amplitude becomes large in the frequency range from 100 kHz to 500 kHz by the piezoelectric sensor mounted on the slider of 5 mm×5 mm or less.

Since, in a slider having the described size, the frequency of the protrusion detection signal or the bump detection signal becomes 1 MHz to 2 MHz, it is possible to obtain detection signals of the side runout detection component and the protrusion detection component separately by using a low-pass filter passing signal having frequency lower than 500 kHz and a high-pass filter passing frequency higher than 500 kHz.

As a result, it is possible to test on a surface undulation of the disk, which is not an object to be evaluated, by detecting an amount of side runout of a rotating disk on the basis of the detection signal of side runout component to thereby improve the evaluation preciseness of a defective disk, which is not acceptable in the prior art.

### BRIEF DESCRIPTION OF THE DRAWINGS

FIG. 1 is a block circuit diagram showing a detection circuit for detecting protrusion and surface undulation of a disk to which a disk defect test method according to the present invention is applied;

FIGS. 2(a)-2(e) show detection waveforms obtained by the detection circuit;

FIG. 3 is a block circuit diagram of a glide tester according to the present invention; and

FIG. 4 shows a protrusion detection head.

### DESCRIPTION OF THE PREFERRED EMBODIMENT

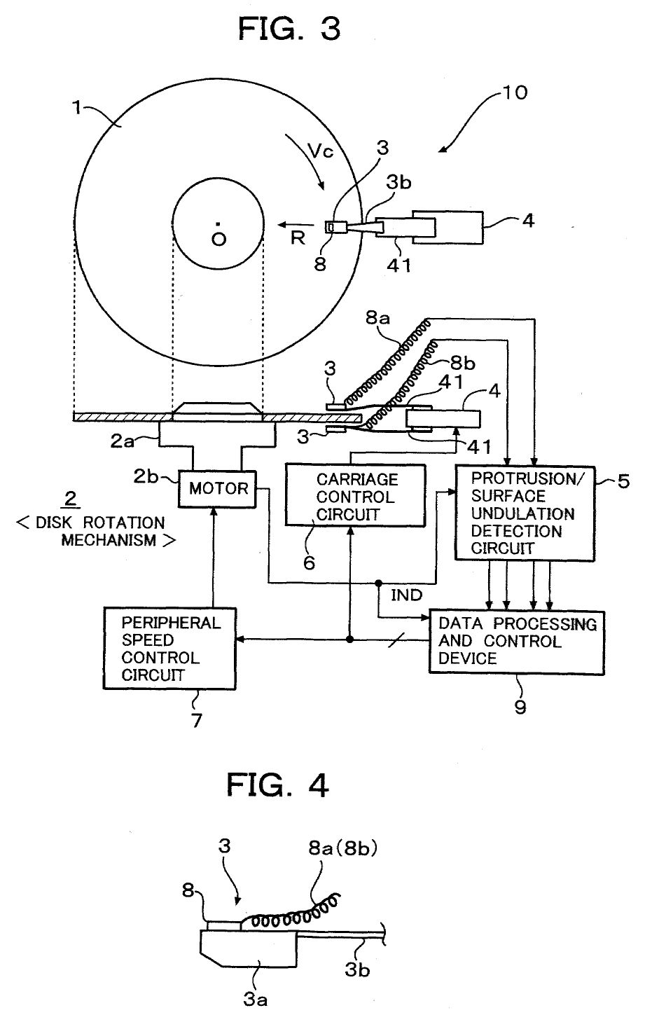

In FIG. 3, a glide tester 10 includes a disk rotation mechanism 2, a pair of protrusion detection heads 3 opposing to respective surfaces of a disk 1, a head carriage 4 for allowing the protrusion detection heads 3 to seek a track having protrusion, a protrusion/surface undulation detection circuit 5 for detecting protrusion/surface undulation according to detection signals from the protrusion detection heads 3, a carriage control circuit 6, a peripheral speed control circuit 7 and a data processing and control device 9. Incidentally, a polishing head, etc., of the glide tester is not shown in FIG. 3.

The disk rotation mechanism 2 includes a spindle 2a for mounting the disk 1 to be tested and a motor 2b for rotating the disk. An encoder is provided on the spindle 2a to generate an index signal IND which becomes a rotation reference of the disk.

In FIG. 3, the disk 1 is rotated about a rotation center O. FIG. 3 shows a relation between the disk 1 and the carriage 4.

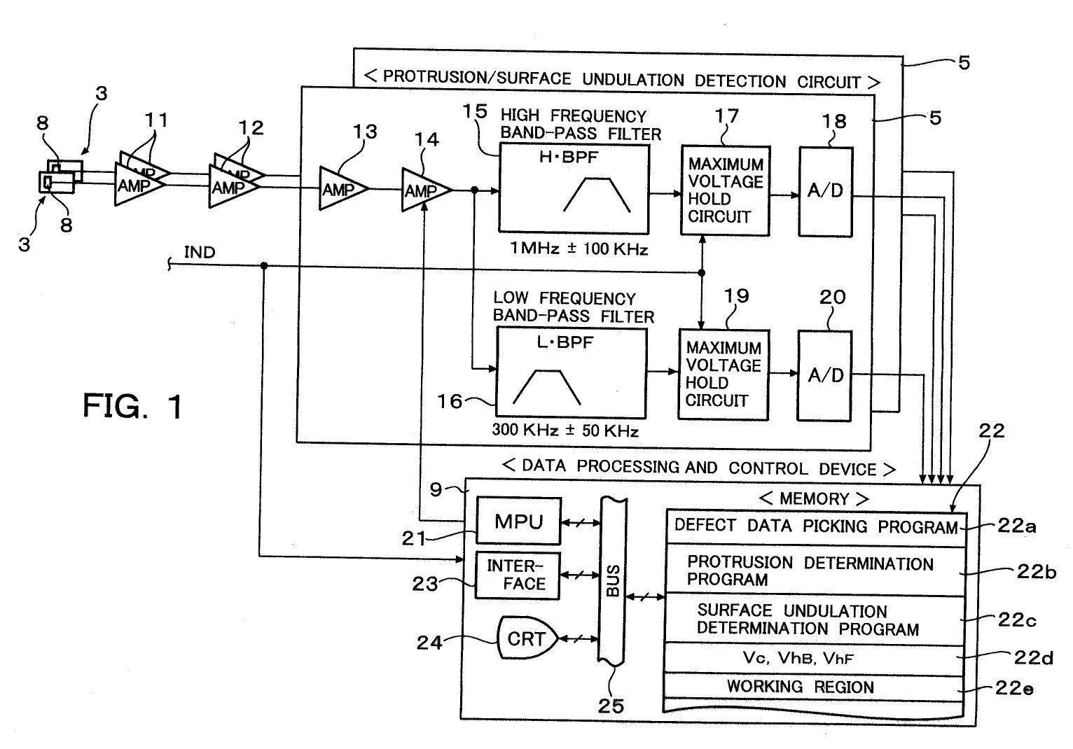

As shown in FIG. 1, the data processing and control device 9 includes a micro processor (MPU) 21, a memory 22, an interface 23 and a CRT display (CRT) 24, which are mutually connected through a bus 25.

As shown in FIGS. 3 and 4, each of the protrusion detection heads 3 corresponding to respective surfaces of the disk includes a slider 3a, a support spring 3b mounted on an arm 41 of the head carriage 4 and a piezo element 8 as a piezo electric sensor mounted on a surface of the corresponding slider 3a. The arm 41 is fixed to a movable pedestal of the head carriage.

Incidentally, shielded leads 8a and 8b (FIG. 3) for deriving the detection signals from the piezo elements 8 are connected to the protrusion/surface undulation detection circuit 5.

In the protrusion test, according to an instruction from the MPU 21, the data processing and control device 9 controls a voice coil motor (not shown) of the head carriage 4 through a carriage control circuit 6 to load the protrusion detection heads 3 on the upper and lower surfaces of the disk 1 by moving the pedestal of the head carriage 4 to thereby access the protrusion detection heads 3 to predetermined tracks.

The disk 1 rotates at a constant reference peripheral speed Vc by the motor 2b under control of the peripheral speed control circuit 7. The slider 3a of each protrusion detection head 3 is floated from the surface of the disk 1 up to a constant level by air-flow generated by the rotation of the disk 1. When there is protrusion higher than the constant level, the protrusion collides with the slider 3a, so that the piezo element 8 is vibrated or deformed. An output signal of the piezo element 8 caused by vibration or deformation thereof is inputted to the protrusion/surface undulation detection circuit 5 and both the protrusion and the surface undulation are generated as detection signal components.

The detection signal components of the protrusion detection head 3 are processed by the MPU 21 and protrusion data or surface undulation data are stored in predetermined areas of the memory 22 and an image showing a position of the protrusion thereof is displayed on the CRT display 24.

The peripheral speed Vc is kept constant since the protrusion detection performance is varied when the amount of floating of the slider 3a is changed. That is, the floating amount of the slider 3a from the disk surface is always kept constant regardless of position of the slider 3a.

The peripheral speed Vc of the disk is determined on the basis of unacceptable height of the protrusion by testing a standard disk having protrusions of various heights. Even if there is a single protrusion having unacceptable height in a disk, the disk is determined as unacceptable (NG).

The standard disk has protrusions having certain heights in respective tracks, which are formed by the thin film edging technology and the heights of the protrusions on the tracks are different each other. The peripheral speed Vc at which the disk becomes unacceptable is determined by the protrusion on the standard disk and is preliminarily stored in a parameter area 22d (FIG. 1) of the memory 22. U.S. Pat. No. 5,898,491 discloses a standard disk of such kind.

The floating level of the slider 3a in this embodiment is in the order of 8 nm from the surface of the disk 1 and the size of the slider 3a is in the order of 3 mm×3 mm. Further, the size of the piezo element 8 is in the order of 2 mm×3 mm. The protrusion/surface undulation detection circuit 5 produces the detection signal components of the protrusion and the surface undulation (side runout) at the peripheral speed Vc of a disk by which the disk is floated by 8 nm.

FIG. 1 shows a circuit construction of the protrusion/surface undulation detection circuit 5. In FIG. 1, the detection signal from the piezo elements 8 of the protrusion detection heads 3 are inputted to the protrusion/surface undulation detection circuit 5 through read amplifiers 11 and buffer amplifiers 12. Although these protrusion/surface undulation detection circuits 5 are provided for the protrusion detection heads 3, respectively, only one of the protrusion/surface undulation detection circuits is shown in FIG. 1.

A buffer amplifier 13 of the protrusion/surface undulation detection circuit 5 receives the detection signal and a variable amplifier 14 of the protrusion/surface undulation detection circuit amplifies the detection signal to 1 to 100 times. The amplified detection signal is inputted to a high frequency band-pass filter (H•BPF) 15 and a low frequency band-pass filter (L•BPF) 16, which constitute a filter circuit portion. The pass-band of the H•BPF 15 is 1 MHz±100 kHz and the pass-band of the L•BPF 16 is 300 kHz±50 kHz.

Incidentally, the pass-band of the H•BPF 15 can be selected in a range ±150 kHz or lower with a center frequency in a range from 1 MHz to 2 MHz and the pass-band of the L•BPF 16 can be selected in a range ±100 kHz or lower with a center frequency in a range from 200 kHz to 400 kHz.

An output of the H•BPF 15 is inputted to a maximum voltage hold circuit (peak hold circuit) 17 for holding a maximum peak voltage obtained in one full track. The maximum peak voltage is A/D converted by an A/D conversion circuit 18 and an output of the A/D conversion circuit 18 is supplied to the data processing and control device 9.

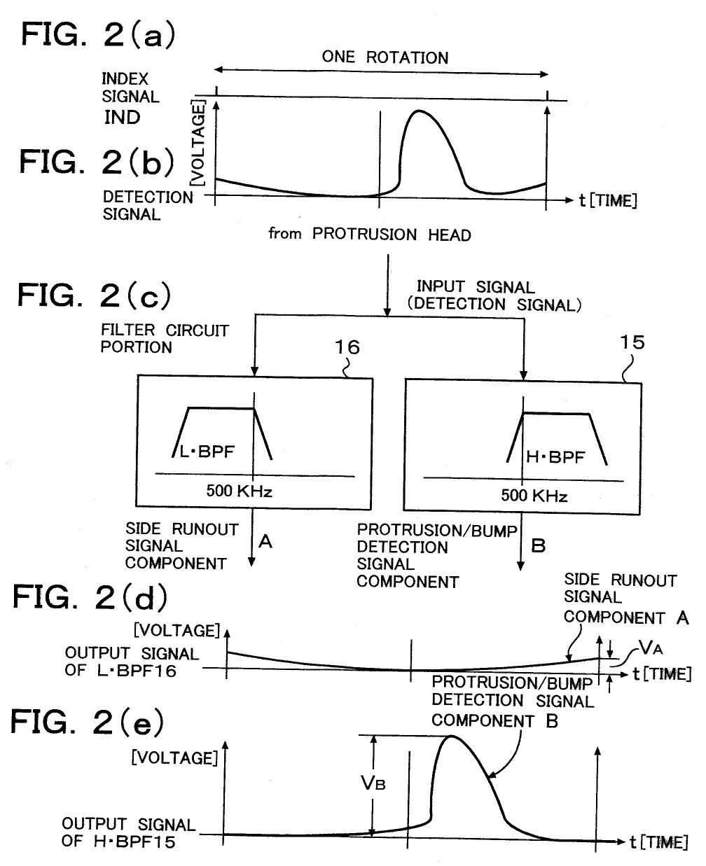

On the other hand, an output of the L•BPF 16 is inputted to a maximum voltage hold circuit 19 for holding the maximum peak voltage obtained in one full track. The maximum peak voltage is A/D converted by an A/D conversion circuit 20 and an output of the A/D conversion circuit 20 is supplied to the data processing and control device 9. The holding values of the maximum voltage hold circuits 17 and 19 are reset by an index signal IND (rising signal shown in FIG. 2(a)).

FIGS. 2(a)-(e) show the detection signal waveforms. Incidentally, in the protrusion test, the protrusion detection heads 3 search protrusion on positioned tracks every time when the index signal IND is generated and are moved to next test tracks according to next index signal IND so that the tracks of the disk 1 to be searched are sequentially updated. Thus, the protrusion test for each of all tracks of the disk is performed during one rotation of the disk.

FIG. 2(a) shows the index signal IND which becomes a rotation reference of one rotation of the disk and FIG. 2(b) shows a detection signal generated by the protrusion detection head 3 which collides with the protrusion in a certain track.

A minute high frequency vibration component such as noise on the detection signal is deleted from the detection signal for the purpose of explanation. Such component can be easily deleted by such as a noise filter provided in the amplifier. As shown in FIGS. 1 and 2(c), the detection signal is inputted to the protrusion/surface undulation detection circuit 5 through the read amplifier 11 and the buffer amplifier 12 and, in the circuit 5, the detection signal amplified by the buffer amplifier 13 and the variable amplifier 14 is inputted to the filter circuits 15 and 16. Thus, a signal A of the side runout signal component showing side runout is outputted from the L•BPF 16 as shown in FIG. 2(d) and a signal B of the protrusion detection component showing height of the protrusion is outputted from the H•BPF 15 as shown in FIG. 2(e).

When the disk 1 having surface undulation or side runout is rotated, the side runout in vertical direction becomes large and an amount (amplitude) of the side runout is increased from the center portion of the disk toward the periphery of the disk. Therefore, the signal A of the side runout component shown in FIG. 2(d) is obtained as the output of the L•BPF 16. Although most of the side turnout is due to undulation of the disk surface, the defective disk is determined by incorporating the eccentricity of the disk into the surface undulation.

Since the piezo element 8 on the slider 3a is floated by air flow and the floating amount is restricted by the support spring 3b, air vibrates correspondingly to vibration of the slider 3a when the side runout becomes large. Pressure due to the air vibration is transmitted to the piezo element 8 through the slider 3a, so that the signal A of the side runout is generated by the piezo element 8.

It is possible to obtain such waveform of the signal component when a 5 mm×5 mm slider having a piezoelectric sensor mounted thereon collides with a protrusion having height in a range from 8 nm to 10-odd nanometers.

Frequency range of voltage when the slider (5 mm×5 mm or less) having the current thin film head collides with protrusion 10 nm high or less was measured. The signal A of the side runout component was obtained in a frequency range 300 kHz±50 kHz. On the basis of this fact, a signal of the side runout component A is obtained by setting the pass-band of the L•BPF 16 to 300 kHz±50 kHz.

In this embodiment, the protrusion detection signal B and the side runout signal A are supplied to the maximum voltage hold circuits (peak hold circuits) 17 and 19, respectively, and maximum amplitude values VB and VA (refer to FIG. 2(d) and FIG. 2(e)) from these peak hold circuits 17 and 19 are converted into digital values, which are inputted to the data processing and control device 9.

The memory 22 of the data processing and control device 9 includes a defect data picking program 22a, a protrusion determination program 22b, a surface undulation determination program 22c, a parameter region 22d storing a peripheral speed Vc and determination reference threshold values VhB and VhF and a working region 22e, etc.

The MPU 21 executes the defect data picking program 22a to search all tracks of the disk 1 by reading the peripheral speed Vc set in the parameter region 22d to thereby obtain the maximum voltages VB and VA of the protrusion detection signal B and the side runout signal A every track. The maximum voltages VB and VA are stored in the working region 21e.

When there are plural protrusions in one track, the maximum values VB and VA among the protrusion components and the side runout components are detected. Further, the protrusion in every track is detected. When the protrusion detection data of all tracks are obtained, the MPU 21 calls the protrusion determination program 22b.

The MPU 21 executes the protrusion determination program 22b to determine whether or not the maximum peak voltage value caused by the protrusion stored in the memory working region 21e exceeds the reference threshold value VhB. If it exceeds the reference threshold value VhB, the tested disk is determined as unacceptable (NG) and the disk is put in an unacceptable cassette. If it does not exceed the reference threshold value VhB, the MPU 21 calls the surface undulation determination program 22c.

The MPU 21 executes the surface undulation determination program 22c to determine whether or not the maximum peak voltage value caused by the side runout stored in the memory working region 21e exceeds the reference threshold value VhF. If it exceeds the reference threshold value VhF, the tested disk is determined as unacceptable (NG) and the disk is put in an unacceptable cassette. If it does not exceed the reference threshold value VhF, the tested disk is determined as acceptable (GD) and is put in the acceptable cassette.

Even when no protrusion is detected in the above mentioned test, the signal A of the side runout component does exist, of course.

In the determination processing mentioned above, the MPU 21 may execute the surface undulation determination program 22c first and then execute the protrusion determination program 22b. In such case, the threshold value VhF of the signal A of the side runout component may be set to another value, which is lower than the threshold value used when the protrusion is detected first.

Incidentally, the threshold values VhB and VhF, which are the standards for determining unacceptability of the disk, are determined by practically testing a number of disks at various peripheral speeds Vc and by performing a protrusion test processing therefor.

Since the above mentioned defect detection processing is executed by calling the respective programs sequentially, the flowchart thereof is not shown.

As described hereinbefore, the acceptability of disk is determined by obtaining the signal B of the protrusion detection component and the signal A of the side runout component in this embodiment. However, it may be possible to perform only the surface undulation test by obtaining only the signal A of the side runout component.

Although, in the embodiment, the signal B of the protrusion detection component and the signal A of the side runout detection component are obtained for every track, it is possible to obtain the signal B of the protrusion detection component and the signal A of the side runout detection component, which become maximum for all tracks. In such case, the hold voltage values of the maximum voltage hold circuits (peak hold circuits) 17 and 19 are not reset until the test for a whole area of a disk is over.

Further, in this embodiment, the signal B of the protrusion detection component and the signal A of the side runout detection component are converted into digital values and the quality of disk is detected by comparing the digital values with predetermined reference values in the data processing and control device. However, it may be possible to provide comparators in the protrusion/surface undulation detection circuit 5 correspondingly to the signal B of the protrusion detection component and the signal A of the side runout detection component and to determine the quality of disk by comparing the signals B and A with reference values corresponding to the threshold values VhB and VhF.

Although the glide tester is described in this embodiment, a protrusion tester having no polishing head, etc., may be constructed similarly to that shown in FIG. 3.

1. A disk defect test method for determining acceptability of a magnetic disk on a basis of a detection signal detected by a piezoelectric sensor mounted on a slider of a head by floating said head by rotating said magnetic disk at a predetermined peripheral speed, comprising the steps of:
obtaining a first signal component corresponding to a side runout of said disk by a low-pass filter; and
comparing a maximum level of the first signal component with a first predetermined reference value.

2. A disk defect test method as claimed in claim 1, wherein the maximum level value of the first signal component is obtained in one track or all tracks of said disk, the floating amount of said head is 10 nm or less, an area of said slider is 5 mm×5 mm or less and said low-pass filter is a band-pass filter in a frequency range of ±100 kHz or less with a center frequency in a range from 200 kHz to 400 kHz.

3. A disk defect test method as claimed in claim 1, wherein said head is a protrusion detection head and the acceptability of said disk is determined by passing the detection signal component through a high-pass filter to obtain a second signal component corresponding to a protrusion detection and comparing a maximum peak value of the second signal component with a second predetermined reference value.

4. A disk defect test method as claimed in claim 3, wherein said piezoelectric sensor is a piezo element, said low-pass filter is a band-pass filter passing low frequency 500 kHz or less and said high-pass filter is a band-pass filter passing frequency higher than 500 kHz.

5. A disk defect test method as claimed in claim 4, wherein the floating amount of said protrusion detection head is 10 nm or less, an area of said slider is 5 mm×5 mm or less and a band width of said high frequency band-pass filter is in a frequency range ±150 kHz or lower with a center frequency in a range from 1 MHz to 2 MHz and said low frequency band-pass filter is in a range ±100 kHz or lower with a center frequency in a range from 200 kHz to 400 kHz.

6. A protrusion detection device for determining acceptability of a magnetic disk on a basis of a detection signal detected by a piezoelectric sensor mounted on a slider of a head by floating said head by rotating said magnetic disk at a predetermined peripheral speed, comprising:
a low-pass filter for obtaining a first signal component corresponding to a side runout of said disk from the detection signal; and
determination means for determining acceptability of said disk by comparing a maximum level of the first signal component with a first predetermined reference value.

7. A protrusion detection device as claimed in claim 6, wherein the maximum level value of the first signal component is obtained in one track or all tracks of the disk, the floating amount of said head is 10 nm or less, an area of said slider is 5 mm×5 mm or less and said low-pass filter is a band-pass filter passing a frequency range of ±100 kHz or less with a center frequency in a range from 200 kHz to 400 kHz.

8. A protrusion detection device as claimed in claim 6, further comprising a high frequency filter for obtaining a second signal component corresponding to a protrusion detection from the detection signal, wherein said determination means determines acceptability of disk by comparing a maximum peak value of the second signal component with a second predetermined reference value.

9. A protrusion detection device as claimed in claim 8, further comprising a first and second peak hold circuits, wherein said first peak hold circuit holds a maximum value of voltage amplitude of the first signal component for one track or all tracks of said disk, said second peak hold circuit holds the maximum peak value of the second signal component for one track or all tracks of said disk and said determination means compares the amplitude voltage obtained by said first peak hold circuit with the first predetermined reference value and compares the maximum peak value with the second predetermined reference value.

10. A protrusion detection device as claimed in claim 9, further comprising a defect detection circuit, an A/D converter circuit and a data processing device, wherein said piezoelectric sensor is a piezo element, a pass-band of said low frequency filter is 500 kHz or lower, a pass-band of said high frequency is higher than 500 kHz, said defect detection circuit includes said first and second peak hold circuits, said low-pass filter and said high-pass filter, said data processing device includes said determination means, and determines acceptability of said disk by an output digital signal of said low-pass filter and an output digital signal of said high-pass filter obtained from said A/D converter.

11. A protrusion detection device as claimed in claim 10, wherein the floating amount of said head is 10 nm or smaller, the size of said slider is 5 mm×5 mm, a band width of said high frequency band-pass filter is ±150 kHz or narrower with a center frequency in a range from 1 MHz to 2 MHz, a band width of said low frequency band-pass filter is ±100 kHz or narrower with a center frequency in a range from 200 kHz to 400 kHz.

12. A glide tester for determining acceptability of a magnetic disk on a basis of a detection signal detected by a piezoelectric sensor mounted on a slider of a head by floating said head by rotating said magnetic disk at a predetermined peripheral speed, comprising:
a low-pass filter for obtaining a first signal component corresponding to side runout of said disk; and
determination means for determining acceptability of said disk by comparing a maximum level of the first signal component with a first predetermined reference value.

13. A glide tester as claimed in claim 12, wherein the maximum level value of the first signal component is obtained in one track or all tracks of said disk, the floating amount of said head is 10 nm or less, an area of said slider is 5 mm×5 mm or less and said low-pass filter is a band-pass filter passing a frequency range of ±100 kHz or less with a center frequency in a range from 200 kHz to 400 kHz.

14. A glide tester as claimed in claim 12, further comprising a high-pass filter for obtaining a second signal component from the detection signal, wherein said determination means further determines acceptability of said disk by comparing a maximum peak value of the second signal component with a second predetermined reference value.

15. A glide tester claimed in claim 14, further comprising a first and second peak hold circuits, wherein said first peak hold circuit holds the maximum value of voltage amplitude of the first signal component for one track or all tracks of said disk, said second peak hold circuit holds the maximum peak value of the first signal component for one track or all tracks of said disk and said determination means compares a voltage amplitude obtained by said first peak hold circuit with the first predetermined reference value and compares the maximum peak value with the second predetermined reference value.

16. A glide tester claimed in claim 15, further comprising a defect detection circuit, an A/D converter circuit and a data processing device, wherein said piezoelectric sensor is a piezo element, a pass-band of said low frequency filter is 500 kHz or lower, a pass-band of said high frequency is higher than 500 kHz, said defect detection circuit includes said first and second peak hold circuits, said low-pass filter and said high-pass filter, said data processing device includes said determination means, and determines acceptability of said disk by an output digital signal of said low-pass filter and an output digital signal of said high-pass filter obtained from said A/D converter.

17. A glide tester as claimed in claim 16, wherein the floating amount of said head is 10 nm or less, an area of said slider is 5 mm×5 mm or less and a band width of said high frequency band-pass filter is in a frequency range ±150 kHz or lower with a center frequency in a range from 1 MHz to 2 MHz and a band width of said low frequency band-pass filter is in a range ±100 kHz or lower with a center frequency in a range of ±100 kHz or less with a center frequency in a range from 200 kHz to 400 kHz.
